(19) United States
(12) Patent Application Publication
(10) Pub. No.: US 2025/0346286 A1
(43) Pub. Date: Nov. 13, 2025

(54) SYSTEMS AND METHODS FOR POSITION SENSING IN A ROADWHEEL ACTUATOR OF A STEER-BY-WIRE STEERING SYSTEM

(71) Applicant: STEERING SOLUTIONS IP HOLDING CORPORATION, Saginaw, MI (US)

(72) Inventors: Yubing Xie, Suzhou (CN); Dandan Li, Suzhou (CN); Sunny Shi, Suzhou (CN); Fantoni Zhang, Suzhou (CN)

(21) Appl. No.: 18/679,614

(22) Filed: May 31, 2024

(30) Foreign Application Priority Data
May 8, 2024 (CN) 2024105645158

(51) Int. Cl. B62D 5/00

(52) U.S. Cl. CPC B62D 5/001

(57) ABSTRACT

An apparatus includes a probe housing assembly of a roadwheel actuator, a first spur gear disposed on a first portion of the probe housing assembly, a pinion shaft arm, and a second spur gear disposed on a first portion of the pinion shaft arm, the second spur gear being configured to mesh with the first spur gear and to rotate with the pinion shaft arm causing the first spur gear to rotate.

### CROSS-REFERENCES TO RELATED APPLICATIONS

This US patent application claims priority to Chinese Patent Application Serial No. 2024105645158, filed May 8, 2024, which is incorporated herein by reference in its entirety.

### TECHNICAL FIELD

This disclosure relates to steer-by-wire steering systems, and in particular, to systems and methods for position sensing in a roadwheel actuator for a steer-by-wire steering system.

### BACKGROUND

A vehicle, such as a car, truck, sport utility vehicle, crossover, mini-van, marine craft, aircraft, all-terrain vehicle, recreational vehicle, or other suitable forms of transportation, typically includes various systems, such as a steering system, which may include an electronic power steering (EPS) system, a steer-by-wire (SbW) steering system, a hydraulic steering system, or other suitable steering system and/or other suitable systems (e.g., such as a braking system, propulsion system, and the like). Such systems of the vehicle typically controls various aspects of vehicle steering (e.g., including providing steering assist to an operator of the vehicle, controlling steerable wheels of the vehicle, and the like), vehicle propulsion, vehicle braking, and the like.

### SUMMARY

This disclosure relates generally to steering systems.

An aspect of the disclosed embodiments includes an apparatus that includes a probe housing assembly of a roadwheel actuator, a first spur gear disposed on a first portion of the probe housing assembly, a pinion shaft arm, and a second spur gear disposed on a first portion of the pinion shaft arm, the second spur gear being configured to mesh with the first spur gear and to rotate with the pinion shaft arm causing the first spur gear to rotate.

Another aspect of the disclosed embodiments includes a system that includes a probe housing assembly of a roadwheel actuator, the probe housing assembly including at least one sensor configured to provide measurement data associated with at least one aspect of a first spur gear. The system also includes the first spur gear disposed on a first portion of the probe housing assembly, a pinion shaft arm, and a second spur gear disposed on a first portion of the pinion shaft arm, the second spur gear being configured to mesh with the first spur gear and to rotate with the pinion shaft arm causing the first spur gear to rotate. The system also includes a controller configured to: receive the measurement data from the at last one sensor; and determine an angle of the pinion shaft arm based on the measurement data.

Another aspect of the disclosed embodiments includes a method that includes: receiving measurement data from at last one sensor disposed in a probe housing assembly that includes a first spur gear configured to mesh with a second spur gear disposed on a pinion shaft arm that is configured to rotate with the pinion shaft arm causing the first spur gear to rotate, wherein the measurement data is associated with at least one aspect of a first spur gear; and determining an angle of the pinion shaft arm based on the measurement data.

These and other aspects of the present disclosure are disclosed in the following detailed description of the embodiments, the appended claims, and the accompanying figures.

### BRIEF DESCRIPTION OF THE DRAWINGS

The disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1 generally illustrates a vehicle according to the principles of the present disclosure.

FIG. 2 generally illustrates a controller according to the principles of the present disclosure.

FIGS. 3A and 3B generally illustrate a traditional probe housing assembly and pinion shaft arm.

FIGS. 4A-4C generally illustrate an improved probe housing assembly and pinion shaft arm according to the principles of the present disclosure.

FIG. 5 is a flow diagram generally illustrating a position sensing method according to the principles of the present disclosure.

### DETAILED DESCRIPTION

The following discussion is directed to various embodiments of the disclosure. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

As described, a vehicle, such as a car, truck, sport utility vehicle, crossover, mini-van, marine craft, aircraft, all-terrain vehicle, recreational vehicle, or other suitable forms of transportation, typically includes various systems, such as a steering system, which may include an electronic power steering (EPS) system, a steer-by-wire (SbW) steering system, a hydraulic steering system, or other suitable steering system and/or other suitable systems (e.g., such as a braking system, propulsion system, and the like). Such systems of the vehicle typically controls various aspects of vehicle steering (e.g., including providing steering assist to an operator of the vehicle, controlling steerable wheels of the vehicle, and the like), vehicle propulsion, vehicle braking, and the like.

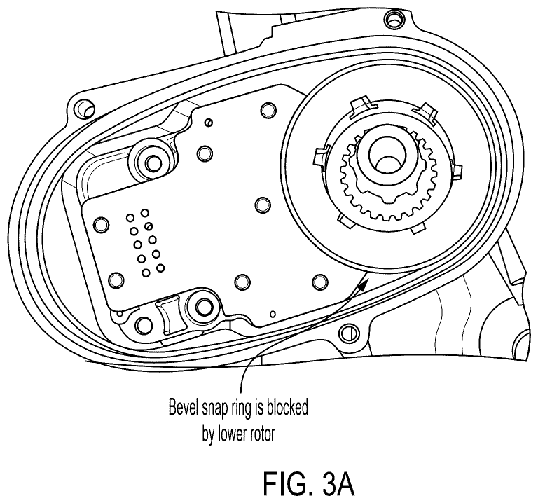

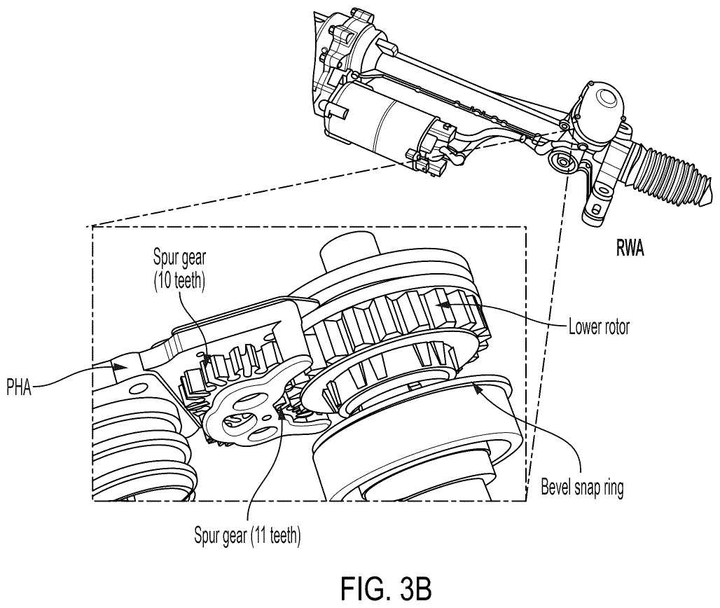

Typically, as is generally illustrated in FIGS. 3A and 3B, for a roadwheel actuator (RWA) of a SbW steering system, the structure of a position sensor is carried by current rack electronic power steering systems, which typically includes a lower rotor and 2 spur gears. Each of the spur gears are meshed with lower rotor by teeth. The lower rotor rotates with the pinion shaft art, causing two spur gears on the probe housing assembly (PHA) to rotate. The position sensor in the PHA is configured to sense the rotation of the spur gears. An associated controller may determine the angle of the pinion shaft arm based on the sensor data from the position sensor.

However, such typical systems are resource intensive (e.g., relatively cost prohibitive and typically have relatively large packaging). Further, removal of the pinion shaft arm may be difficult due to the bevel snap ring being blocked by the lower rotor (e.g., the bevel snap ring cannot be removed with the lower rotor in place).

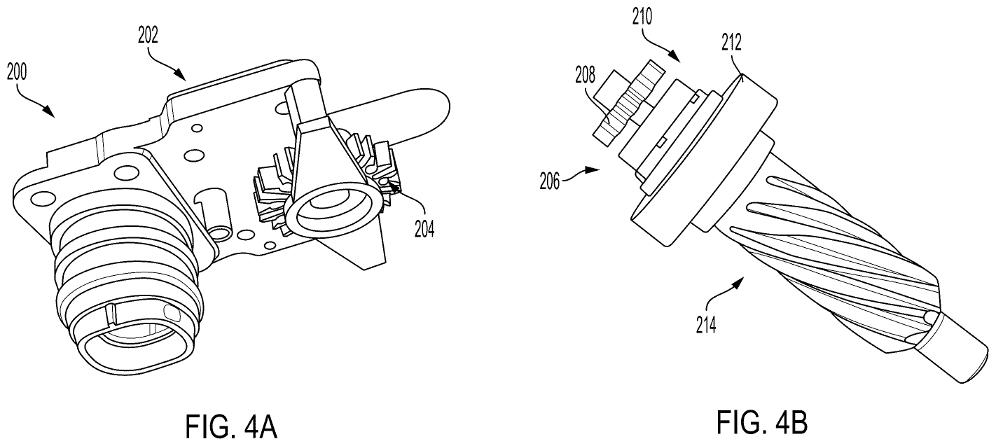

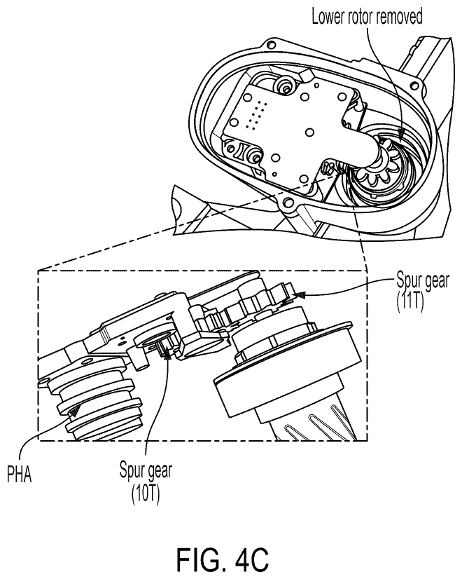

Accordingly, systems and methods, such as those described herein, configured to provide improved position sensing for an RWA, while reducing the difficulty associated with removing the pinion shaft and/or bevel snap ring, may be desirable. In some embodiments, the systems and methods described herein may be configured to include one spur gear pressed or disposed on pinion shaft, while removing and eliminating the need for the lower rotor. The spur gear on the pinion shaft art may include 11 teeth (11 T), which may mesh with and drive another spur gear (e.g., which may have 10 teeth (10 T) disposed on the PHA. The systems and methods described herein may be configured provided an improved design for the PHA and pinion shaft arm, as is generally illustrated in FIGS. 4A-4C.

In some embodiments, the systems and methods described herein may be configured to calculate the steering angle based on the angle of the spur gear on the pinion shaft arm plus the cycle. For example, the systems and methods described herein may be configured to receive sensor data from the position sensor of the PHA. The systems and methods described herein may be configured to determine the angle of the pinion shaft arm based on the angle of the spur gear on the pinion shaft arm and the cycle of the spur gear. The systems and methods described herein may be configured to determine the steering angle based on the angle of the pinion shaft arm.

Additionally, or alternatively, the systems and methods described herein may be configured to determine the angle of the pinion shaft arm based on a sum of the absolute angle of the spur gear on the PHA and the cycle of the of the spur gear on the PHA, divided by a fear ratio (e.g., 1.1).

The systems and methods described herein may be configured to provide a pinion shaft arm and PHA having reduced manufacturing costs and resources by removing the cost of the lower rotor, and improving the efficiency of removing the spline on the pinion shaft. Additionally, or alternatively, the systems and methods described herein may be configured to provide a relatively smaller PHA (e.g., further reducing manufacturing costs).

In some embodiments, an apparatus, according to the principles of the present disclosure, includes a PHA of an RWA. The apparatus may also include a first spur gear disposed on a first portion of the PHA. The first spur gear may include 10 teeth or any suitable number of teeth. The apparatus may also include a pinion shaft arm and a second spur gear disposed on a first portion of the pinion shaft arm. The second spur gear may include 11 teeth or any suitable number of teeth. The second spur gear may be configured to mesh with the first spur gear. The second spur gear may rotate with the pinion shaft arm causing the first spur gear to rotate.

In some embodiments, the apparatus may also include a bevel snap ring disposed between the first portion of the pinion shaft arm and a second portion of the pinion shaft arm. A circumference an inner portion of the bevel snap ring may be larger than a circumference of an outer portion of the second spur gear. The bevel snap ring may be removable from the pinion shaft arm with the second spur gear disposed on the first portion of the pinion shaft arm.

In some embodiments, the PHA is configured to house at least one sensor. The at least one sensor may include at least one positon sensor. A controller associated with the roadwheel actuator may receive at least one measurement from the at least one sensor. The controller may determine an angle of the pinion shaft arm based on the at least one measurement. The controller may determine a steering angle based on the angle of the pinion shaft arm.

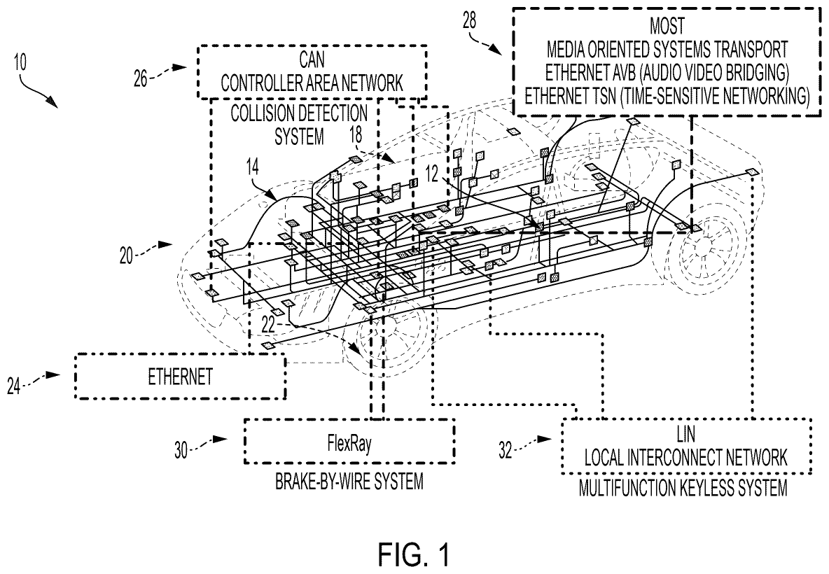

FIG. 1 generally illustrates a vehicle 10 according to the principles of the present disclosure. The vehicle 10 may include any suitable vehicle, such as a car, a truck, a sport utility vehicle, a mini-van, a crossover, any other passenger vehicle, any suitable commercial vehicle, or any other suitable vehicle. While the vehicle 10 is illustrated as a passenger vehicle having wheels and for use on roads, the principles of the present disclosure may apply to other vehicles, such as planes, boats, trains, drones, or other suitable vehicles.

The vehicle 10 includes a vehicle body 12 and a hood 14. A passenger compartment 18 is at least partially defined by the vehicle body 12. Another portion of the vehicle body 12 defines an engine compartment 20. The hood 14 may be moveably attached to a portion of the vehicle body 12, such that the hood 14 provides access to the engine compartment 20 when the hood 14 is in a first or open position and the hood 14 covers the engine compartment 20 when the hood 14 is in a second or closed position. In some embodiments, the engine compartment 20 may be disposed on rearward portion of the vehicle 10 than is generally illustrated.

The passenger compartment 18 may be disposed rearward of the engine compartment 20, but may be disposed forward of the engine compartment 20 in embodiments where the engine compartment 20 is disposed on the rearward portion of the vehicle 10. The vehicle 10 may include any suitable propulsion system including an internal combustion engine, one or more electric motors (e.g., an electric vehicle), one or more fuel cells, a hybrid (e.g., a hybrid vehicle) propulsion system comprising a combination of an internal combustion engine, one or more electric motors, and/or any other suitable propulsion system.

In some embodiments, the vehicle 10 may include a petrol or gasoline fuel engine, such as a spark ignition engine. In some embodiments, the vehicle 10 may include a diesel fuel engine, such as a compression ignition engine. The engine compartment 20 houses and/or encloses at least some components of the propulsion system of the vehicle 10. Additionally, or alternatively, propulsion controls, such as an accelerator actuator (e.g., an accelerator pedal), a brake actuator (e.g., a brake pedal), a handwheel, and other such components are disposed in the passenger compartment 18 of the vehicle 10. The propulsion controls may be actuated or controlled by a operator of the vehicle 10 and may be directly connected to corresponding components of the propulsion system, such as a throttle, a brake, a vehicle axle, a vehicle transmission, and the like, respectively. In some embodiments, the propulsion controls may communicate signals to a vehicle computer (e.g., drive by wire) which in turn may control the corresponding propulsion component of the propulsion system. As such, in some embodiments, the vehicle 10 may be an autonomous vehicle.

In some embodiments, the vehicle 10 includes a transmission in communication with a crankshaft via a flywheel or clutch or fluid coupling. In some embodiments, the transmission includes a manual transmission. In some embodiments, the transmission includes an automatic transmission. The vehicle 10 may include one or more pistons, in the case of an internal combustion engine or a hybrid vehicle, which cooperatively operate with the crankshaft to generate force, which is translated through the transmission to one or more axles, which turns wheels 22. When the vehicle 10 includes one or more electric motors, a vehicle battery, and/or fuel cell provides energy to the electric motors to turn the wheels 22.

The vehicle 10 may include automatic vehicle propulsion systems, such as a cruise control, an adaptive cruise control, automatic braking control, other automatic vehicle propulsion systems, or a combination thereof. The vehicle 10 may be an autonomous or semi-autonomous vehicle, or other suitable type of vehicle. The vehicle 10 may include additional or fewer features than those generally illustrated and/or disclosed herein.

In some embodiments, the vehicle 10 may include an Ethernet component 24, a controller area network (CAN) bus 26, a media oriented systems transport component (MOST) 28, a FlexRay component 30 (e.g., brake-by-wire system, and the like), and a local interconnect network component (LIN) 32. The vehicle 10 may use the CAN bus 26, the MOST 28, the FlexRay Component 30, the LIN 32, other suitable networks or communication systems, or a combination thereof to communicate various information from, for example, sensors within or external to the vehicle, to, for example, various processors or controllers within or external to the vehicle. The vehicle 10 may include additional or fewer features than those generally illustrated and/or disclosed herein.

In some embodiments, the vehicle 10 may include a steering system, such as an EPS system, a steering-by-wire steering system (e.g., which may include or communicate with one or more controllers that control components of the steering system without the use of mechanical connection between the handwheel and wheels 22 of the vehicle 10), a hydraulic steering system (e.g., which may include a magnetic actuator incorporated into a valve assembly of the hydraulic steering system), or other suitable steering system.

The steering system may include an open-loop feedback control system or mechanism, a closed-loop feedback control system or mechanism, or combination thereof. The steering system may be configured to receive various inputs, including, but not limited to, a handwheel position, an input torque, one or more roadwheel positions, other suitable inputs or information, or a combination thereof.

Additionally, or alternatively, the inputs may include a handwheel torque, a handwheel angle, a motor velocity, a vehicle speed, an estimated motor torque command, other suitable input, or a combination thereof. The steering system may be configured to provide steering function and/or control to the vehicle 10. For example, the steering system may generate an assist torque based on the various inputs. The steering system may be configured to selectively control a motor of the steering system using the assist torque to provide steering assist to the operator of the vehicle 10.

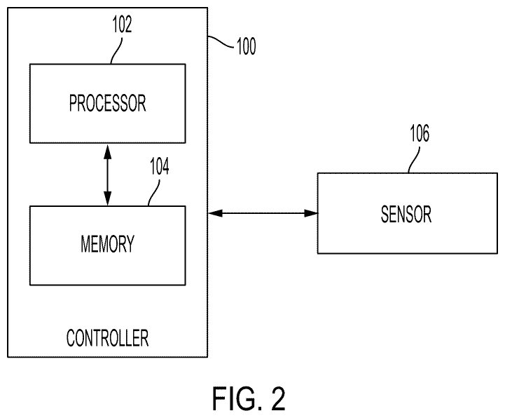

In some embodiments, the vehicle 10 may include a controller, such as controller 100, as is generally illustrated in FIG. 2. The controller 100 may include any suitable controller, such as an electronic control unit or other suitable controller. The controller 100 may be configured to control, for example, the various functions of the steering system and/or various functions of the vehicle 10. The controller 100 may include a processor 102 and a memory 104. The processor 102 may include any suitable processor, such as those described herein. Additionally, or alternatively, the controller 100 may include any suitable number of processors, in addition to or other than the processor 102. The memory 104 may comprise a single disk or a plurality of disks (e.g., hard drives), and includes a storage management module that manages one or more partitions within the memory 104. In some embodiments, memory 104 may include flash memory, semiconductor (solid state) memory or the like. The memory 104 may include Random Access Memory (RAM), a Read-Only Memory (ROM), or a combination thereof. The memory 104 may include instructions that, when executed by the processor 102, cause the processor 102 to, at least, control various aspects of the vehicle 10.

The controller 100 may receive one or more signals from various measurement devices or sensors 106 indicating sensed or measured characteristics of the vehicle 10. The sensors 106 may include any suitable sensors, measurement devices, and/or other suitable mechanisms. For example, the sensors 106 may include one or more torque sensors or devices, one or more handwheel position sensors or devices, one or more motor position sensor or devices, one or more position sensors or devices, one or more radar sensors or devices, one or more lidar sensors or devices, one or more sonar sensors or devices, one or more image capturing sensors or devices, other suitable sensors or devices, or a combination thereof. The one or more signals may indicate a handwheel torque, a handwheel angle, a motor velocity, a vehicle speed, other suitable information, or a combination thereof.

In some embodiments, the controller 100 may be configured to determine an angle of a pinon shaft arm of a RWA, as is generally illustrated in FIGS. 4A-4C. The RWA may include or be associated with a PHA 200, which may include a first spur gear 204 disposed on a first portion 202 of the PHA 200. The first spur gear 204 may include 10 teeth or any suitable number of teeth. A pinion shaft arm 206 may include a second spur gear 208 disposed on a first portion 210 of the pinion shaft arm 206. The second spur gear 208 may include 11 teeth or any suitable number of teeth. The second spur gear 208 may be configured to mesh with the first spur gear 204. The second spur gear 208 may rotate with the pinion shaft arm 206 causing the first spur gear 204 to rotate.

The pinion shaft arm 206 may include a bevel snap ring 212 disposed between the first portion 210 of the pinion shaft arm 206 and a second portion 214 of the pinion shaft arm 206. A circumference an inner portion of the bevel snap ring 212 may be larger than a circumference of an outer portion of the second spur gear 208. The bevel snap ring 212 may be removable from the pinion shaft arm 206 with the second spur gear 208 disposed on the first portion 210 of the pinion shaft arm 206 (e.g., the bevel snap ring 212 may be large enough to be removed from the pinion shaft arm 206, passing over the second spur gear 208, and without remove other components of the pinion shaft arm 206).

The PHA 200 may include at least one sensor 106, which may include a position sensor or any suitable sensor. The controller 100 may receive at least one measurement from the at least one sensor 106. The controller 100 may determine an angle of the pinion shaft arm 206 based on the at least one measurement. The controller 100 may determine a steering angle based on the angle of the pinion shaft arm 206.

The controller 100 may control various aspects of the steering system of the vehicle 10 based on the steering angle.

In some embodiments, the controller 100 may perform the methods described herein. However, the methods described herein as performed by the controller 100 are not meant to be limiting, and any type of software executed on a controller or processor can perform the methods described herein without departing from the scope of this disclosure. For example, a controller, such as a processor executing software within a computing device, can perform the methods described herein.

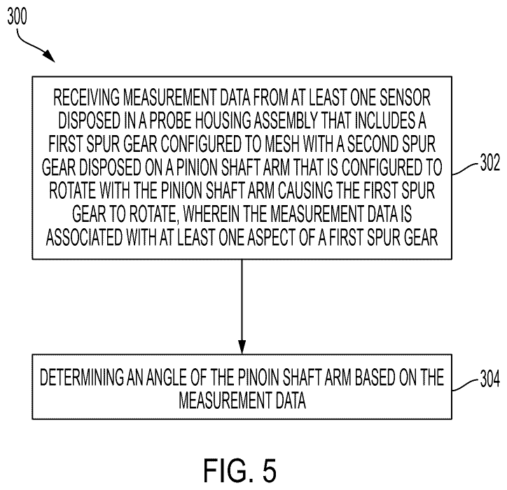

FIG. 5 is a flow diagram generally illustrating position sensing method 300 according to the principles of the present disclosure. At 302, the method 300 receives measurement data from at last one sensor disposed in a probe housing assembly that includes a first spur gear configured to mesh with a second spur gear disposed on a pinion shaft arm that is configured to rotate with the pinion shaft arm causing the first spur gear to rotate. The measurement data is associated with at least one aspect of a first spur gear.

At 304, the method 300 determines an angle of the pinion shaft arm based on the measurement data.

In some embodiments, an apparatus includes a probe housing assembly of a roadwheel actuator, a first spur gear disposed on a first portion of the probe housing assembly, a pinion shaft arm, and a second spur gear disposed on a first portion of the pinion shaft arm, the second spur gear being configured to mesh with the first spur gear and to rotate with the pinion shaft arm causing the first spur gear to rotate.

In some embodiments, the first spur gear includes 10 teeth. In some embodiments, the second spur gear includes 11 teeth. In some embodiments, the apparatus also includes a bevel snap ring disposed between the first portion of the pinion shaft arm and a second portion of the pinion shaft arm. In some embodiments, a circumference an inner portion of the bevel snap ring is larger than a circumference of an outer portion of the second spur gear. In some embodiments, the bevel snap ring is removable from the pinion shaft arm with the second spur gear disposed on the first portion of the pinion shaft arm. In some embodiments, the probe housing assembly is configured to house at least one sensor. In some embodiments, the at least one sensor includes at least one positon sensor. In some embodiments, a controller associated with the roadwheel actuator receives at least one measurement from the at least one sensor. In some embodiments, the controller is configured to determine an angle of the pinion shaft arm based on the at least one measurement. In some embodiments, the roadwheel actuator is associated with a steer-by-wire steering system.

In some embodiments, a system includes a probe housing assembly of a roadwheel actuator, the probe housing assembly including at least one sensor configured to provide measurement data associated with at least one aspect of a first spur gear. The system also includes the first spur gear disposed on a first portion of the probe housing assembly, a pinion shaft arm, and a second spur gear disposed on a first portion of the pinion shaft arm, the second spur gear being configured to mesh with the first spur gear and to rotate with the pinion shaft arm causing the first spur gear to rotate. The system also includes a controller configured to: receive the measurement data from the at last one sensor; and determine an angle of the pinion shaft arm based on the measurement data.

In some embodiments, the first spur gear includes 10 teeth. In some embodiments, the second spur gear includes 11 teeth. In some embodiments, the system also includes a bevel snap ring disposed between the first portion of the pinion shaft arm and a second portion of the pinion shaft arm. In some embodiments, a circumference an inner portion of the bevel snap ring is larger than a circumference of an outer portion of the second spur gear. In some embodiments, the bevel snap ring is removable from the pinion shaft arm with the second spur gear disposed on the first portion of the pinion shaft arm. In some embodiments, the at least one sensor includes at least one positon sensor. In some embodiments, the roadwheel actuator is associated with a steer-by-wire steering system.

In some embodiments, a method includes: receiving measurement data from at last one sensor disposed in a probe housing assembly that includes a first spur gear configured to mesh with a second spur gear disposed on a pinion shaft arm that is configured to rotate with the pinion shaft arm causing the first spur gear to rotate, wherein the measurement data is associated with at least one aspect of a first spur gear; and determining an angle of the pinion shaft arm based on the measurement data.

The above discussion is meant to be illustrative of the principles and various embodiments of the present disclosure. Numerous variations and modifications will become apparent to those skilled in the art once the above disclosure is fully appreciated. It is intended that the following claims be interpreted to embrace all such variations and modifications.

The word “example” is used herein to mean serving as an example, instance, or illustration. Any aspect or design described herein as “example” is not necessarily to be construed as preferred or advantageous over other aspects or designs. Rather, use of the word “example” is intended to present concepts in a concrete fashion. As used in this application, the term “or” is intended to mean an inclusive “or” rather than an exclusive “or”. That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an implementation” or “one implementation” throughout is not intended to mean the same embodiment or implementation unless described as such.

Implementations the systems, algorithms, methods, instructions, etc., described herein can be realized in hardware, software, or any combination thereof. The hardware can include, for example, computers, intellectual property (IP) cores, application-specific integrated circuits (ASICs), programmable logic arrays, optical processors, programmable logic controllers, microcode, microcontrollers, servers, microprocessors, digital signal processors, or any other suitable circuit. In the claims, the term “processor” should be understood as encompassing any of the foregoing hardware, either singly or in combination. The terms “signal” and “data” are used interchangeably.

As used herein, the term module can include a packaged functional hardware unit designed for use with other components, a set of instructions executable by a controller (e.g., a processor executing software or firmware), processing circuitry configured to perform a particular function, and a self-contained hardware or software component that interfaces with a larger system. For example, a module can include an application specific integrated circuit (ASIC), a Field Programmable Gate Array (FPGA), a circuit, digital logic circuit, an analog circuit, a combination of discrete circuits, gates, and other types of hardware or combination thereof. In other embodiments, a module can include memory that stores instructions executable by a controller to implement a feature of the module.

Further, in one aspect, for example, systems described herein can be implemented using a general-purpose computer or general-purpose processor with a computer program that, when executed, carries out any of the respective methods, algorithms, and/or instructions described herein. In addition, or alternatively, for example, a special purpose computer/processor can be utilized which can contain other hardware for carrying out any of the methods, algorithms, or instructions described herein.

Further, all or a portion of implementations of the present disclosure can take the form of a computer program product accessible from, for example, a computer-usable or computer-readable medium. A computer-usable or computer-readable medium can be any device that can, for example, tangibly contain, store, communicate, or transport the program for use by or in connection with any processor. The medium can be, for example, an electronic, magnetic, optical, electromagnetic, or a semiconductor device. Other suitable mediums are also available.

The above-described embodiments, implementations, and aspects have been described in order to allow easy understanding of the present disclosure and do not limit the present disclosure. On the contrary, the disclosure is intended to cover various modifications and equivalent arrangements included within the scope of the appended claims, which scope is to be accorded the broadest interpretation so as to encompass all such modifications and equivalent structure as is permitted under the law.

What is claimed is:

1. An apparatus comprising:
a probe housing assembly of a roadwheel actuator;
a first spur gear disposed on a first portion of the probe housing assembly;
a pinion shaft arm; and
a second spur gear disposed on a first portion of the pinion shaft arm, the second spur gear being configured to mesh with the first spur gear and to rotate with the pinion shaft arm causing the first spur gear to rotate.

2. The apparatus of claim 1, wherein the first spur gear includes 10 teeth.

3. The apparatus of claim 1, wherein the second spur gear includes 11 teeth.

4. The apparatus of claim 1, further comprising a bevel snap ring disposed between the first portion of the pinion shaft arm and a second portion of the pinion shaft arm.

5. The apparatus of claim 4, wherein a circumference an inner portion of the bevel snap ring is larger than a circumference of an outer portion of the second spur gear.

6. The apparatus of claim 4, wherein the bevel snap ring is removable from the pinion shaft arm with the second spur gear disposed on the first portion of the pinion shaft arm.

7. The apparatus of claim 1, wherein the probe housing assembly is configured to house at least one sensor.

8. The apparatus of claim 7, wherein the at least one sensor includes at least one positon sensor.

9. The apparatus of claim 7, wherein a controller associated with the roadwheel actuator receives at least one measurement from the at least one sensor.

10. The apparatus of claim 9, wherein the controller is configured to determine an angle of the pinion shaft arm based on the at least one measurement.

11. The apparatus of claim 1, wherein the roadwheel actuator is associated with a steer-by-wire steering system.

12. A system comprising:
a probe housing assembly of a roadwheel actuator, the probe housing assembly including at least one sensor configured to provide measurement data associated with at least one aspect of a first spur gear;
the first spur gear disposed on a first portion of the probe housing assembly;
a pinion shaft arm;
a second spur gear disposed on a first portion of the pinion shaft arm, the second spur gear being configured to mesh with the first spur gear and to rotate with the pinion shaft arm causing the first spur gear to rotate; and
a controller configured to:
receive the measurement data from the at last one sensor; and
determine an angle of the pinion shaft arm based on the measurement data.

13. The system of claim 12, wherein the first spur gear includes 10 teeth.

14. The system of claim 12, wherein the second spur gear includes 11 teeth.

15. The system of claim 12, further comprising a bevel snap ring disposed between the first portion of the pinion shaft arm and a second portion of the pinion shaft arm.

16. The system of claim 15, wherein a circumference an inner portion of the bevel snap ring is larger than a circumference of an outer portion of the second spur gear.

17. The system of claim 15, wherein the bevel snap ring is removable from the pinion shaft arm with the second spur gear disposed on the first portion of the pinion shaft arm.

18. The system of claim 12, wherein the at least one sensor includes at least one positon sensor.

19. The system of claim 12, wherein the roadwheel actuator is associated with a steer-by-wire steering system.

20. A method comprising:
receiving measurement data from at last one sensor disposed in a probe housing assembly that includes a first spur gear configured to mesh with a second spur gear disposed on a pinion shaft arm that is configured to rotate with the pinion shaft arm causing the first spur gear to rotate, wherein the measurement data is associated with at least one aspect of a first spur gear; and
determining an angle of the pinion shaft arm based on the measurement data.
